(19) United States
(12) Patent Application Publication
(10) Pub. No.: US 2023/0060166 A1
(43) Pub. Date: Mar. 2, 2023

(54) ESTIMATION METHOD AND CONTROL DEVICE FOR WIRE ELECTRICAL DISCHARGE MACHINE

(71) Applicant: FANUC CORPORATION, Yamanashi (JP)

(72) Inventors: Daiki WATANABE, Yamanashi-ken (JP); Shouta IRIE, Yamanashi-ken (JP)

(21) Appl. No.: 17/793,681

(22) PCT Filed: Jan. 22, 2021
(86) PCT No.: PCT/JP2021/002123

§ 371 Date: Jul. 19, 2022

(30) Foreign Application Priority Data
Jan. 28, 2020 (JP) 2020011666

(51) Int. Cl. B23H 7/10; B23H 1/02; B23H 11/00

(52) U.S. Cl. CPC B23H 7/10; B23H 1/02; B23H 11/006

(57) ABSTRACT

An estimation method and a control device for a wire electrical discharge machine, for estimating whether a wire electrode has disconnected on the basis of information obtained from a motor included in a feed mechanism of the wire electrode. The control device is provided with a roller for feeding a wire electrode in a direction of feeding out, and a motor for causing the roller to rotate. The control device includes: an acquisition unit for acquiring a value for a disturbance load based on a drive current of the motor, a value for the rotational speed of the motor, and/or a value for a torque command for causing the motor to rotate at a commanded speed determined in advance; and an estimation unit for estimating whether the wire electrode has disconnected on the basis of the disturbance load, the rotational speed, and/or the torque command acquired by the acquisition unit.

### TECHNICAL FIELD

The present invention relates to an estimation method and a control device for a wire electrical discharge machine. In particular, the present invention relates to an estimation method and a control device for a wire electrical discharge machine, which estimate whether or not a wire electrode of the wire electrical discharge machine is disconnected.

### BACKGROUND ART

A wire electrical discharge machine is generally equipped with a tension sensor that detects a tension of the wire electrode. As an example of such a tension sensor, for example, a “wire electrode tension sensor” is disclosed in JP 2002-340711 A.

### SUMMARY OF THE INVENTION

A general type of such a wire electrical discharge machine detects the tension of the wire electrode by a tension sensor. Consequently, a function of estimating whether or not the wire electrode is disconnected is realized. In this instance, it may be considered that, if it were possible to estimate whether or not the wire electrode is disconnected without using a tension sensor, the tension sensor could be omitted from the configuration of the wire electrical discharge machine. Further, if the tension sensor could be omitted from the configuration of the wire electrical discharge machine, it would be considered advantageous in terms of simplifying the mechanical structure of the wire electrical discharge machine, making the wire electrical discharge machine smaller in scale, and reducing the cost of constituent components.

Thus, the present invention has the object of providing an estimation method and a control device for a wire electrical discharge machine, which based on information obtained from a motor included in a wire electrode feeding mechanism, estimates whether or not a wire electrode is disconnected.

One aspect of the present invention is characterized by a control device for a wire electrical discharge machine equipped with a roller configured to feed a wire electrode in a feeding direction by rotation, and a motor configured to cause the roller to rotate, the control device for the wire electrical discharge machine including an acquisition unit configured to acquire at least one from among a value of a disturbance load based on a drive current of the motor, a value of a rotational speed of the motor, and a value of a torque command in order to cause the motor to rotate at a predetermined command speed, and an estimation unit configured to estimate whether or not the wire electrode is disconnected, based on at least one from among the disturbance load, the rotational speed, and the torque command acquired by the acquisition unit.

Still another aspect of the present invention is characterized by an estimation method for estimating whether or not a wire electrode is disconnected, in relation to a wire electrical discharge machine equipped with a roller configured to feed the wire electrode in a feeding direction by rotation, and a motor configured to cause the roller to rotate, the estimation method including an acquisition step of acquiring at least one from among a disturbance load based on a drive current of the motor, a rotational speed of the motor, and a torque command in order to cause the motor to rotate at a predetermined command speed, and an estimation step of estimating whether or not the wire electrode is disconnected, based on at least one from among the disturbance load, the rotational speed, and the torque command acquired in the acquisition step.

According to the aspects of the present invention, the estimation method and the control device for the wire electrical discharge machine are provided, in which based on information obtained from the motor included in the wire electrode feeding mechanism, it is estimated whether or not the wire electrode is disconnected.

### BRIEF DESCRIPTION OF THE DRAWINGS

FIG. 1 is a configuration diagram showing the overall configuration of a wire electrical discharge machine according to an embodiment of the present invention;

FIG. 2 is a simplified configuration diagram of a wire electrode feeding mechanism provided in the wire electrical discharge machine according to the embodiment;

FIG. 3 is a simplified configuration diagram of a control device for the wire electrical discharge machine according to the present embodiment;

FIG. 4A is a time chart showing an example of transitioning of a disturbance load, a rotational speed, and a torque command of a first motor, and FIG. 4B is a time chart showing an example of transitioning of a disturbance load, a rotational speed, and a torque command of a second motor; and

FIG. 5 is a flowchart showing the process flow of an estimation method according to the present embodiment.

### DESCRIPTION OF THE INVENTION

A preferred embodiment in relation to an estimation method and a control device for a wire electrical discharge machine according to the present invention will be presented and described in detail below with reference to the accompanying drawings. However, it should be understood that explanation of well-known matters may be omitted herein.

### Embodiments

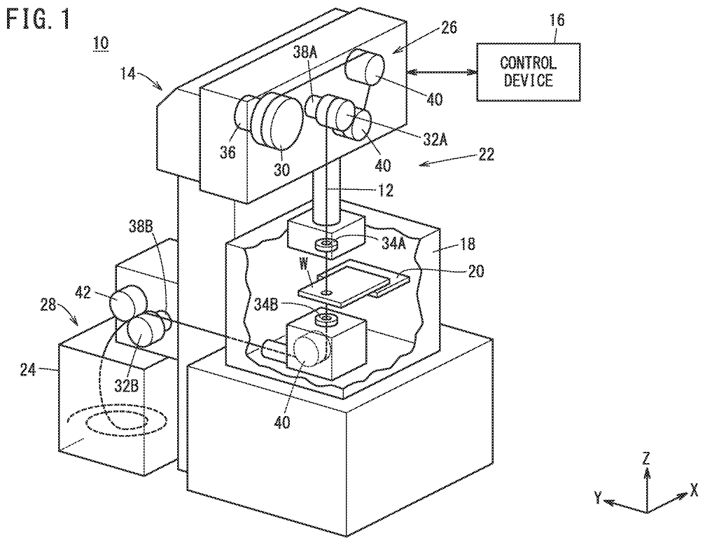

FIG. 1 is a configuration diagram showing the overall configuration of a wire electrical discharge machine 10 according to an embodiment of the present invention. In FIG. 1, an X direction, a Y direction, and a Z direction which are indicated by the arrows are directions that are perpendicular to each other.

The wire electrical discharge machine 10 is a machine tool that carries out electrical discharge machining on a workpiece W (an object to be machined) by causing an electric discharge to be generated (in an inter-electrode space) between a wire electrode 12 and the workpiece W.

The wire electrical discharge machine 10 according to the present embodiment is equipped with a machine main body 14 and a control device 16. The machine main body 14 is a machine that executes electrical discharge machining by way of the wire electrode 12. The control device 16 is a device that controls the machine main body 14, which is also generally referred to as a numerical control device. In particular, according to the present embodiment, the control device 16 serves to estimate whether or not the wire electrode 12 is disconnected or broken.

Among these elements, the machine main body 14 comprises a work-pan 18, a support base 20, a feeding mechanism 22, and a collection box 24. The work-pan 18 is a pan in which a working fluid is stored. The working fluid is a liquid having a dielectric property. The working fluid, for example, is deionized water. The support base 20 is a pedestal which is disposed inside the work-pan 18 and which is immersed in the working fluid. The support base 20 has a surface that extends in the X direction and the Y direction. By such a surface, the support base 20 supports the workpiece W within the working fluid.

In connection with the support base 20, the wire electrical discharge machine 10 may further include a support base moving mechanism that causes the support base 20 to move along the X direction, the Y direction, and the Z direction. Although a detailed description thereof is omitted in the present embodiment, the support base moving mechanism is configured to include, for example, a plurality of servo motors.

The feeding mechanism 22 is a mechanism that feeds or delivers the wire electrode 12 along a feeding direction, in a manner so that the wire electrode 12 passes through the workpiece W that is supported by the support base 20. Further, the collection box 24 serves to accommodate the wire electrode 12 after having passed through the workpiece W. Moreover, the “feeding direction” is defined as a direction toward a first roller 32A when viewed from a wire bobbin 30 to be described hereinafter, as a direction toward a second roller 32B when viewed from the first roller 32A, and as a direction toward the collection box 24 when viewed from the second roller 32B.

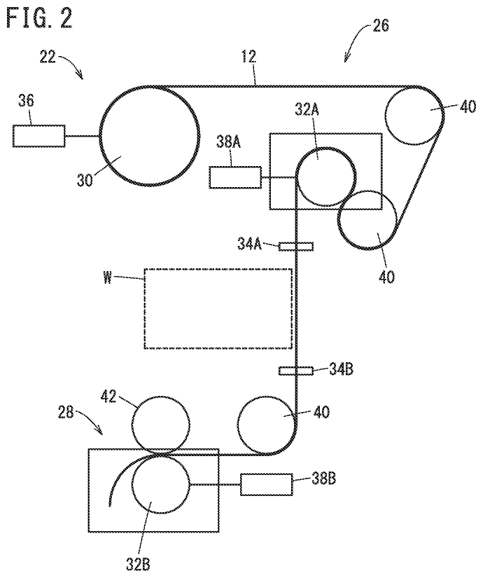

FIG. 2 is a simplified configuration diagram of the feeding mechanism 22 for feeding the wire electrode 12 that is provided in the wire electrical discharge machine 10 according to the embodiment.

A description will further be given concerning the feeding mechanism 22. The feeding mechanism 22 includes a supplying system 26 that feeds the wire electrode 12 toward the workpiece W, and a collecting system 28 that feeds the wire electrode 12 after having passed through the workpiece W, toward the collection box 24.

The supplying system 26 comprises the wire bobbin 30, the first roller 32A, a first die guide 34A, a torque motor 36, and a first motor 38A. The wire bobbin 30 is a bobbin that is capable of rotating. The wire electrode 12 is wound around the wire bobbin 30 in a manner so as to be capable of being reeled out therefrom. The first roller 32A is a rotatable roller around which the wire electrode 12 that is reeled out from the wire bobbin 30 is wound. The first die guide 34A is a die guide that guides the wire electrode 12 from the first roller 32A toward the workpiece W. The first die guide 34A is disposed inside the work-pan 18. The torque motor 36, which will be described again later, is a motor that applies a torque to the wire bobbin 30 in a direction opposite to the direction of rotation of the wire bobbin 30 that feeds the wire electrode 12 along the feeding direction. Hereinafter, the torque in a direction opposite to the direction of rotation in which the wire electrode 12 is fed along the feeding direction may also be referred to as a “reverse torque” for the sake of convenience. The first motor 38A is a motor that causes the first roller 32A to rotate integrally with its own rotating shaft. The first motor 38A, for example, is a servo motor that is connected to the first roller 32A.

Each of the first motor 38A and the torque motor 36 is provided with a non-illustrated encoder. In accordance with this feature, the rotational speed of the rotating shaft can be detected for each of the first motor 38A and the torque motor 36. Moreover, hereinafter, the term “rotation of the rotating shaft of the first motor 38A” may also simply be referred to as “rotation of the first motor 38A”. Further the term “rotation of the rotating shaft of the torque motor 36” may also simply be referred to as “rotation of the torque motor 36”.

The foregoing describes the configuration of the supplying system 26. As shown in FIG. 2, the supplying system 26 may further include an auxiliary roller 40, which is a roller around which the wire electrode 12 is wound between the wire bobbin 30 and the first roller 32A. The supplying system 26 may be provided with one auxiliary roller 40 or a plurality of the auxiliary rollers 40. Further, the supplying system 26 may include a non-illustrated first die guide moving mechanism that causes the first die guide 34A to move along a direction parallel to the X-Y plane of FIG. 1. Although a detailed description thereof is omitted in the present embodiment, the first die guide moving mechanism is configured to include, for example, a servo motor.

Subsequently, a description will be given concerning the configuration of the collecting system 28 of the feeding mechanism 22. The collecting system 28 is equipped with a second die guide 34B, the second roller 32B, a third roller 42, and a second motor 38B. The second die guide 34B is a die guide that guides the wire electrode 12 after having passed through the workpiece W. The second die guide 34B is disposed inside the work-pan 18. Further, the second roller 32B and the third roller 42 are rotatable rollers that sandwich therebetween the wire electrode 12 after having passed through the second die guide 34B. The third roller 42, in order to carry out gripping and releasing thereof, is provided so as to be capable of being moved close to and away from the second roller 32B. The second motor 38B is a servo motor according to the present embodiment. A rotating shaft of the second motor 38B is connected to the second roller 32B. Consequently, when a drive current is supplied to the second motor 38B, the rotating shaft of the second motor 38B and the second roller 32B rotate together in an integral manner.

In the same manner as the first motor 38A, an encoder is provided in the second motor 38B. The rotational speed of the rotating shaft of the second motor 38B is detected by the encoder that is provided in the second motor 38B. Moreover, hereinafter, in the same manner as the first motor 38A and the torque motor 36, the term “rotation of the rotating shaft of the second motor 38B” may also simply be referred to as “rotation of the second motor 38B”.

The foregoing describes the configuration of the collecting system 28. Moreover, in the same manner as the supplying system 26, the collecting system 28 may further include one or more auxiliary rollers 40. The auxiliary roller 40 provided in the collecting system 28, for example, is disposed between the second die guide 34B and the second roller 32B (and/or the third roller 42). The wire electrode 12 is wound around the auxiliary roller 40. Further, the collecting system 28 may include a non-illustrated second die guide moving mechanism that causes the second die guide 34B to move along a direction parallel to the X-Y plane of FIG. 1. The second die guide moving mechanism is configured to include, for example, a servo motor, in the same manner as the aforementioned first die guide moving mechanism.

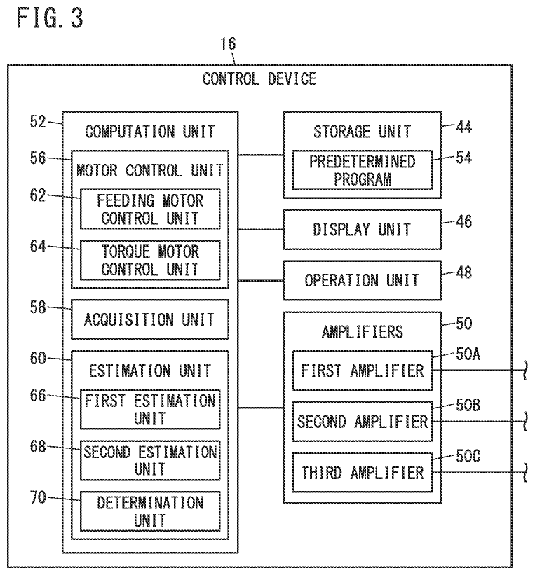

FIG. 3 is a simplified configuration diagram of the control device 16 for the wire electrical discharge machine 10 according to the present embodiment.

Subsequently, a description will be given concerning the configuration of the control device 16 for the wire electrical discharge machine 10. The control device 16 is equipped with a storage unit 44, a display unit 46, an operation unit 48, amplifiers 50, and a computation unit 52. The storage unit 44 serves to store information. The storage unit 44 is constituted by hardware such as, for example, a RAM (Random Access Memory), a ROM (Read Only Memory), and the like. A predetermined program 54 for controlling the feeding mechanism 22 is stored in advance in the storage unit 44 of the present embodiment. The display unit 46 serves to display information, and for example, the display unit 46 is a display device equipped with a liquid crystal screen. The operation unit 48 is operated by an operator in order to input information (instructions) to the control device 16. The operation unit 48 is constituted, for example, by a keyboard, a mouse, or a touch panel that can be mounted on the screen (liquid crystal screen) of the display unit 46.

According to the present embodiment, the amplifiers 50 are servo amplifiers. The amplifiers 50 comprise a first amplifier 50A, a second amplifier 50B, and a third amplifier 50C. Among these members, the first amplifier 50A and the second amplifier 50B serve to feedback control the first motor 38A and the second motor 38B based on a command output from a later-described computation unit 52. Further, the third amplifier 50C serves to feedback control the torque motor 36 based on a command output from the computation unit 52.

The computation unit 52 processes information by carrying out computations. The computation unit 52 is constituted by hardware, for example, such as a CPU (Central Processing Unit), a GPU (Graphics Processing Unit), and the like. The computation unit 52 comprises a motor control unit 56, an acquisition unit 58, and an estimation unit 60. These respective units can be realized by the computation unit 52 executing a predetermined program 54.

Hereinafter, a description will be given sequentially concerning each of such units that are provided in the computation unit 52. Moreover, in the following, when the aforementioned first motor 38A and the second motor 38B are described without being distinguished in particular, both of such members will be referred to simply as “feeding motors 38”. Further, when the aforementioned first roller 32A and the second roller 32B are described without being distinguished in particular, both of such members will be referred to simply as “feeding rollers 32”.

The motor control unit 56 controls each of the feeding motors 38 and the torque motor 36 via the amplifiers 50. The motor control unit 56 includes a feeding motor control unit 62 and a torque motor control unit 64 which will be described below.

The feeding motor control unit 62 serves to control the feeding motors 38, from among the feeding motors 38 and the torque motor 36. The feeding motor control unit 62 outputs a command to the first amplifier 50A and the second amplifier 50B in order to cause the feeding motors 38 thereof to rotate at a predetermined rotational speed. Hereinafter, the rotational speed indicated by such a command may also be referred to as a “command speed”.

The feeding motor control unit 62 issues a command to the first amplifier 50A to control the command speed (a first command speed) of the first motor 38A, and issues a command to the second amplifier 50B to control the command speed (a second command speed) of the second motor 38B. The second command speed is higher than the first command speed. Accordingly, when the two feeding motors 38 are rotated at the respective command speeds, the wire electrode 12 is pulled from the first roller 32A toward the second roller 32B and the third roller 42, so that the wire electrode 12 is stretched between the first roller 32A and the second roller 32B.

However, in a state in which the wire electrode 12 is wound and extended between the two feeding rollers 32 as described above, there is a concern that the rotational speed of the first motor 38A may exceed the first command speed as a result of being influenced by the rotational speed of the second motor 38B. At the same time, the rotational speed of the second motor 38B may become less than the second command speed as a result of being influenced by the rotational speed of the first motor 38A. Thus, the feeding motor control unit 62 outputs a command to the first amplifier 50A and the second amplifier 50B, to thereby indicate the torque that should be made to be generated by the first motor 38A and the second motor 38B. Hereinafter, this command, or alternatively, a torque indicated by such a command, may also be referred to as a “torque command”.

The feeding motor control unit 62 outputs the torque command to the first amplifier 50A, to thereby indicate a torque (a reverse torque) in a direction opposite to the rotational direction in which the wire electrode 12 is fed along the feeding direction. Consequently, the first amplifier 50A is capable of causing the commanded reverse torque to be generated in the first motor 38A, and causing the rotational speed of the first motor 38A to be reduced to the first command speed. Further, the feeding motor control unit 62 outputs the torque command to the second amplifier 50B, to thereby indicate a torque (hereinafter, for the sake of convenience, referred to as a forward torque) in the rotational direction in which the wire electrode 12 is fed along the feeding direction. Consequently, the second amplifier 50B is capable of causing the commanded forward torque to be generated in the second motor 38B, and causing the rotational speed of the second motor 38B to rise to the second command speed.

The torque motor control unit 64 outputs a torque command to the third amplifier 50C indicating a reverse torque of a predetermined magnitude. The predetermined magnitude can be specified and changed by each of the other units provided in the computation unit 52. Alternatively, by operating the operation unit 48, the predetermined magnitude can be specified and changed by the operator. Hereinafter, the “reverse torque of a predetermined magnitude” may also simply be referred to as a “predetermined reverse torque”. In accordance with the torque command output from the torque motor control unit 64, the third amplifier 50C causes the predetermined reverse torque to be generated in the torque motor 36, and is thereby capable of preventing the wire electrode 12 from being excessively fed out from the wire bobbin 30 due to being influenced by rotation of the feeding motors 38.

Next, a description will be given concerning the acquisition unit 58. In relation to both the first motor 38A and the second motor 38B, the acquisition unit 58 acquires at least one of a disturbance load value, a rotational speed value, or a torque command value.

In this instance, the disturbance load is a difference between a drive current when the feeding motors 38 are rotated at the command speed in the case of not being affected by the influence of a disturbance, and a drive current when the feeding motors 38 are rotated at the command speed in a case of being affected by the influence of a disturbance.

For example, it is assumed that the rotational speed of the first motor 38A deviates from the first command speed due to the disturbance. In this instance, as the disturbance, there are included a force received by the first motor 38A due to the reverse torque of the torque motor 36, a tension of the wire electrode 12, and a frictional force applied to the wire electrode 12 by the third roller 42. In this case, as noted previously, the first amplifier 50A adjusts the drive current based on the torque command. The disturbance load of the first motor 38A is obtained based on the drive current after having been subjected to such an adjustment.

Further, it is assumed that the rotational speed of the second motor 38B deviates from the second command speed due to the disturbance. In this instance, as the disturbance, there are included a force received by the second motor 38B due to the reverse torque of the torque motor 36, a tension of the wire electrode 12, and a frictional force applied to the wire electrode 12 by the third roller 42. In this case, as noted previously, the second amplifier 50B adjusts the drive current based on the torque command. The disturbance load of the second motor 38B is obtained based on the drive current after having been subjected to such an adjustment.

The estimation unit 60 estimates whether or not the wire electrode 12 is disconnected based on the disturbance load, the rotational speed, and the torque command acquired by the acquisition unit 58. The estimation unit 60 includes a first estimation unit 66, a second estimation unit 68, and a determination unit 70, as described below.

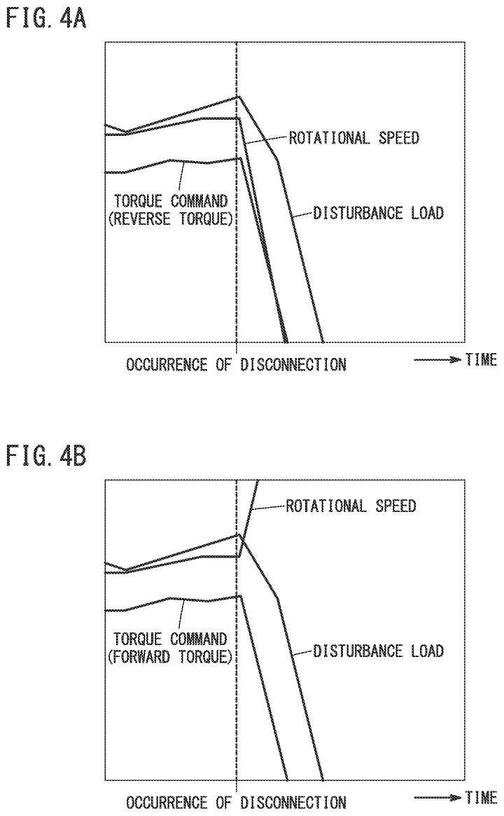

FIG. 4A is a time chart showing an example of transitioning of the disturbance load, the rotational speed, and the torque command of the first motor 38A.

First, a description will be given concerning the first estimation unit 66. However, before that, a description will be given concerning changes in the disturbance load, the rotational speed, and the torque command of the first motor 38A when the wire electrode 12 that is fed by the feeding mechanism 22 is disconnected. As shown in FIG. 4A, when a disconnection occurs, all of the disturbance load, the rotational speed, and the torque command (the reverse torque) of the first motor 38A sharply decrease.

The reason why the disturbance load of the first motor 38A decreases after the disconnection is because the tension of the wire electrode 12 between the two feeding rollers 32 becomes zero due to the wire electrode 12 having been disconnected. Further, the reason why the rotational speed of the first motor 38A decreases after the disconnection is because, even after the disturbance load has decreased, immediately after the disconnection occurs, a reverse torque, which corresponds to the disturbance load prior to the decrease, is applied to the first motor 38A. In addition, the reason why the torque command of the first motor 38A decreases after the disconnection is because, in order for the rotational speed of the first motor 38A to be made to rise to the first command speed, the feeding motor control unit 62 causes the reverse torque that is generated by the first motor 38A to be made smaller.

Based on the foregoing, the first estimation unit 66 estimates whether or not the wire electrode 12 is disconnected. More specifically, the first estimation unit 66 estimates whether or not the value acquired by the acquisition unit 58, from among the disturbance load, the rotational speed, and the torque command of the first motor 38A, has fallen outside of a predetermined range.

The “predetermined range” is determined for each one of the disturbance load, the rotational speed, and the torque command, and is a range of allowable values when the wire electrode 12 is being fed without the occurrence of a disconnection. Hereinafter, the “predetermined range” may also be referred to as a “first range” for the sake of convenience. The first range can be determined in advance by experiment. The first range is defined, for example, as a range of plus or minus several percent (an allowable margin of error) with respect to a reference value that is expected from the experimental results.

Further, the first estimation unit 66 may estimate whether or not the wire electrode 12 is disconnected, based on whether or not, from among the disturbance load, the rotational speed, and the torque command of the first motor 38A, an amount of change per unit time in the value acquired by the acquisition unit 58 has exceeded a predetermined threshold value.

The “predetermined threshold value” is determined for each one of the amount of change per unit time in the disturbance load, the rotational speed, and the torque command, and is a lower limit value of the amount of change in the case that the wire electrode 12 is fed without the occurrence of a disconnection. Hereinafter, the “predetermined threshold value” may also be referred to as a “first threshold value” for the sake of convenience. The first threshold value can be determined in advance by experiment. The first threshold value is defined, for example, as a value of plus or minus several percent (an allowable margin of error) with respect to a reference value that is expected from the experimental results.

The first estimation unit 66 may perform the estimation based on at least one of the disturbance load, the rotational speed, the torque command, or the amount of change therein per unit time. However, it is more preferable for the first estimation unit 66 to perform such an estimation on the basis of two or more of such values. In that case, the first estimation unit 66 will perform the estimation at least two times. In the case that the first estimation unit 66 performs the estimation two times (although not limited to this feature, e.g., performing an estimation based on the disturbance load, and an estimation based on the torque command), if both the two estimations estimate that “the wire electrode 12 is disconnected,” the estimations are regarded as its own final estimation result. Consequently, for example, even if the influence of noise leads to an incorrect estimation result in the estimation based on one of the disturbance load and the torque command, it can be avoided that such a result will become the final estimation result. Thus, the reliability of the estimation by the first estimation unit 66 can be improved.

Moreover, in the case that the estimation made by the first estimation unit 66 is performed three times or more, if all of the estimations estimate that “the wire electrode 12 is disconnected,” the estimations may be regarded as being the final estimation result of the first estimation unit 66. Such a feature is most preferable from the standpoint of the reliability of the estimation. However, the case in which the estimation is performed three or more times is not necessarily limited to the above feature. For example, if a majority of the three or more estimations estimate that “the wire electrode 12 is disconnected”, then the first estimation unit 66 may regard such an estimation as being its own final estimation result.

FIG. 4B is a time chart showing an example of transitioning of a disturbance load, a rotational speed, and a torque command of the second motor 38B.

Next, a description will be given concerning the second estimation unit 68. However, before that, a description will be given concerning changes in the disturbance load, the rotational speed, and the torque command of the second motor 38B when the wire electrode 12 that is fed by the feeding mechanism 22 is disconnected. As shown in FIG. 4B, when a disconnection occurs, the disturbance load and the torque command (the forward torque) of the second motor 38B sharply decrease. On the other hand, the rotational speed of the second motor 38B sharply rises.

The reason why the disturbance load of the second motor 38B decreases after the disconnection is because the tension of the wire electrode 12 between the two feeding rollers 32 becomes zero due to the wire electrode 12 having been disconnected. Further, the reason why the rotational speed of the second motor 38B rises after the disconnection is because, even after the disturbance load has decreased, immediately after the disconnection occurs, a forward torque, which corresponds to the disturbance load prior to the decrease, is applied to the second motor 38B. Furthermore, the reason why the torque command of the second motor 38B decreases after the disconnection is because, in order for the rotational speed of the second motor 38B to be made to decrease to the second command speed, the feeding motor control unit 62 causes the forward torque that is generated by the second motor 38B to be made smaller.

Based on the foregoing, the second estimation unit 68 estimates whether or not the wire electrode 12 is disconnected. More specifically, the second estimation unit 68 estimates whether or not the value acquired by the acquisition unit 58, from among the disturbance load, the rotational speed, and the torque command of the second motor 38B, has fallen outside of a predetermined range.

The “predetermined range” is determined for each one of the disturbance load, the rotational speed, and the torque command, and is a range of allowable values when the wire electrode 12 is being fed without the occurrence of a disconnection. Hereinafter, the “predetermined range” may also be referred to as a “second range” for the sake of convenience. In the same manner as the first range, the second range can be determined in advance by experiment.

Further, the second estimation unit 68 may estimate whether or not the wire electrode 12 is disconnected, based on whether or not an amount of change per unit time in the value acquired by the acquisition unit 58, from among the disturbance load, the rotational speed, and the torque command of the second motor 38B, has exceeded a predetermined threshold value.

The “predetermined threshold value” is determined for each one of the amount of change per unit time in the disturbance load, the rotational speed, and the torque command, and is a lower limit value of the amount of change in the case that the wire electrode 12 is fed without the occurrence of a disconnection. Hereinafter, the “predetermined threshold value” may also be referred to as a “second threshold value” for the sake of convenience. In the same manner as the first threshold value, the second threshold value can be obtained in advance by experiment.

The second estimation unit 68 may perform the estimation based on at least one of the disturbance load, the rotational speed, the torque command, or the amount of change therein per unit time. However, it is more preferable for the second estimation unit 68 to perform such an estimation on the basis of two or more of such values. In that case, the second estimation unit 68 will perform the estimation at least two times. In the case that the second estimation unit 68 performs the estimation two times (although not limited to this feature, e.g., performing an estimation based on the disturbance load, and an estimation based on the torque command), if both the two estimations estimate that “the wire electrode 12 is disconnected,” the estimations are regarded as its own final estimation result. In the case that the result of the estimation that was performed two times is split, the reason why the disconnection of the wire electrode 12 is not regarded as being the final estimation result is the same reason as that of the first estimation unit 66.

Further, the following feature is also the same as with the first estimation unit 66. In the case that the estimation is performed three times or more by the second estimation unit 68, if all of the three or more estimations or a majority thereof estimate that “the wire electrode 12 is disconnected”, then the second estimation unit 68 may preferably regard such an estimation as being its own final estimation result. Consequently, the reliability of the estimation by the second estimation unit 68 can be improved.

The estimation results of the first estimation unit 66 and the second estimation unit 68 are input to the determination unit 70. In the case that both the first estimation unit 66 and the second estimation unit 68 estimate that the wire electrode 12 is disconnected, the determination unit 70 determines as the estimation result that the wire electrode 12 is disconnected.

In the determination unit 70, in the case that the estimation results of the first estimation unit 66 and the second estimation unit 68 differ from each other, the determination unit 70 determines as the estimation result that the wire electrode 12 is not disconnected. Consequently, even if one of the first estimation unit 66 and the second estimation unit 68 makes an erroneous estimation, for example, due to the influence of noise, it is possible to prevent such an erroneous estimation result from being determined as the final estimation result. In other words, by adopting a configuration in which cross checking is carried out between the first estimation unit 66 and the second estimation unit 68, the reliability of the estimation result is further improved.

The estimation result determined by the determination unit 70 can be notified to the operator by displaying the estimation result on the display unit 46. In this case, the estimation result may be displayed only in the case that the wire electrode 12 is estimated to be disconnected. Consequently, the operator is able to rapidly recognize that there is a possibility that the wire electrode 12 has become disconnected.

In the case of having estimated that the wire electrode 12 is disconnected, the control device 16 may cause the rotation of each of the first motor 38A and the second motor 38B to stop. Consequently, in the case it is estimated that the wire electrode 12 is disconnected, the electrical discharge machining can be safely brought to an end.

Further, in the case of having estimated that the wire electrode 12 is disconnected, the control device 16 may stop the voltage from being applied to the wire electrode 12. In other words, the voltage is applied to the wire electrode 12 only when the electrical discharge machining is carried out. In the case it is estimated that the wire electrode 12 is disconnected, by stopping the voltage from being supplied, the electrical discharge machining can be safely brought to an end.

The above is an example of the configuration of the control device 16 according to the present embodiment. Next, a description will be given concerning an estimation method, which is executed by the above-described control device 16, for estimating whether or not the wire electrode 12 is disconnected.

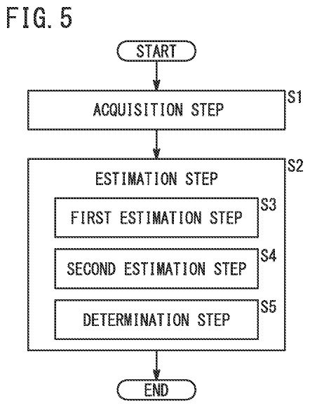

FIG. 5 is a flowchart showing the process flow of the estimation method according to the present embodiment.

In FIG. 5, the acquisition step (S1) is a step of acquiring at least one value from among the disturbance load based on the drive current of the feeding motors 38, the rotational speed of the feeding motors 38, and the torque command of the feeding motors 38. The present step is executed by the acquisition unit 58.

The feeding motors 38 include the first motor 38A and the second motor 38B. In the acquisition step, at least one of the values of the disturbance loads of both of these motors, the values of the rotational speeds of the feeding motors 38, or the values of the torque commands thereof is acquired.

The estimation step (S2) is a step of estimating whether or not the wire electrode 12 is disconnected based on at least one from among the disturbance loads, the rotational speeds, and the torque commands acquired in the acquisition step. The estimation step includes a first estimation step (S3), a second estimation step (S4), and a determination step (S5).

The first estimation step is a step of estimating whether or not the wire electrode 12 is disconnected based on at least one from among the disturbance load, the rotational speed, and the torque command of the first motor 38A. The present step is executed by the first estimation unit 66.

The second estimation step is a step of estimating whether or not the wire electrode 12 is disconnected based on at least one from among the disturbance load, the rotational speed, and the torque command of the second motor 38B. The present step is executed by the second estimation unit 68.

Moreover, the order in which the first estimation step and the second estimation step are executed may be reversed from the order shown in FIG. 5. Further, if it is not estimated that the wire electrode 12 is disconnected in one estimation step that is executed first from among the first estimation step and the second estimation step, the other estimation step that is executed thereafter may be skipped.

The determination step is a step of determining, as the estimation result, that the wire electrode 12 is disconnected, in the case it is estimated in both of the first estimation step and the second estimation step that the wire electrode 12 is disconnected. The present step is executed by the determination unit 70.

By executing the estimation method as described above, the control device 16 is capable of easily estimating whether or not the wire electrode 12 is disconnected.

More specifically, according to the present embodiment, the estimation method and the control device 16 for the wire electrical discharge machine 10 are provided, in which based on information acquired from the feeding motors 38 included in the wire electrode feeding mechanism 22 for feeding the wire electrode 12, it is estimated whether or not the wire electrode 12 is disconnected.

According to the control device 16 of the present embodiment, it is not necessary for the wire electrical discharge machine 10 to be equipped with a tension sensor for estimating whether or not the wire electrode 12 is disconnected. Therefore, according to the control device 16 of the present embodiment, the tension sensor can be omitted, and accordingly the mechanical structure of the wire electrical discharge machine 10 is simplified, made smaller in scale, and the cost of constituent components is reduced, advantageously.

### [Modifications]

The embodiment has been described above as one example of the present invention. It goes without saying that various modifications or improvements are capable of being added to the above-described embodiment. Further, it is clear from the scope of the claims that other modes to which such modifications or improvements have been added can be included within the technical scope of the present invention.

### (Modification 1)

As explained in the embodiment, it is more preferable for the estimation of whether or not the wire electrode 12 is disconnected to be performed by both of the first estimation unit 66 and the second estimation unit 68. However, the present invention is not limited to this feature, and either one of the first estimation unit 66 and the second estimation unit 68 may be omitted from the configuration of the control device 16. Further, in such a case, the result of the estimation performed by either one of the estimation units may be determined without modification as being the final estimation result.

According to the present modification, cross checking is not carried out between the first estimation unit 66 and the second estimation unit 68. However, it is possible to perform the estimation itself of whether or not the wire electrode 12 is disconnected. Further, by omitting either one of the first estimation unit 66 and the second estimation unit 68, the configuration of the control device 16 can be made simpler than that of the aforementioned embodiments.

### (Modification 2)

In the embodiment, a description was given to the effect that it is possible to estimate whether or not the wire electrode 12 has become disconnected based on the torque command. The present invention is not limited to this feature, and the control device 16 may estimate whether or not the wire electrode 12 is disconnected on the basis of a torque that is fed back from the feeding motors 38 to the amplifiers 50. Even in the case of this modification, it is possible to estimate whether or not the wire electrode 12 is disconnected.

### (Modification 3)

The above-described embodiment and the modifications thereof may be optionally combined within a range in which no technical inconsistencies occur.

[Inventions that can be Obtained from the Embodiment]

The inventions that can be grasped from the above-described embodiment and the modifications thereof will be described below.

### <First Invention>

The present invention is characterized by the control device (16) for the wire electrical discharge machine (10) equipped with the rollers (32) that feed the wire electrode (12) in the feeding direction by rotation, and the motors (38) that cause the rollers (32) to rotate, the control device including the acquisition unit (58) that acquires at least one from among the value of the disturbance load based on the drive current of the motors (38), the value of the rotational speed of the motors (38), and the value of the torque command in order to cause the motors (38) to rotate at the predetermined command speed, and the estimation unit (60) that estimates whether or not the wire electrode (12) is disconnected, based on at least one from among the disturbance load, the rotational speed, and the torque command acquired by the acquisition unit (58).

In accordance with such features, it is possible to provide the control device (16) for the wire electrical discharge machine (10) in which, based on the information obtained from the motors (38) included in the feeding mechanism (22) for feeding the wire electrode (12), it is estimated whether or not the wire electrode (12) is disconnected.

The estimation unit (60) may estimate whether or not the wire electrode (12) is disconnected, based on whether or not, from among the disturbance load, the rotational speed, and the torque command, the value acquired by the acquisition unit (58) has fallen outside of the predetermined range. In accordance with this feature, based on the information obtained from the motors (38), it is estimated whether or not the wire electrode (12) is disconnected.

The estimation unit (60) may estimate whether or not the wire electrode (12) is disconnected, based on whether or not, from among the disturbance load, the rotational speed, and the torque command, the value acquired by the acquisition unit (58) has fallen outside of the predetermined range, and may further estimate whether or not the wire electrode (12) is disconnected, based on whether or not, from among the disturbance load, the rotational speed, and the torque command, the amount of change per unit time in the value acquired by the acquisition unit (58) has exceeded the predetermined threshold value, and in the case that the value acquired by the acquisition unit (58) has fallen outside of the range, and the amount of change has exceeded the threshold value, then as the estimation result, the wire electrode (12) may be determined to be disconnected. In accordance with such features, the reliability of the estimation result is improved.

The estimation unit (60) may estimate whether or not the wire electrode (12) is disconnected, based on whether or not, from among the disturbance load, the rotational speed, and the torque command, the amount of change per unit time in the value acquired by the acquisition unit (58) has exceeded the predetermined threshold value. In accordance with this feature, based on the information obtained from the motors (38), it is estimated whether or not the wire electrode (12) is disconnected.

The rollers (32) may be configured to feed the wire electrode (12) toward the workpiece (W) from the wire bobbin (30) on which the wire electrode (12) is wound. In accordance with this feature, based on the information obtained from the motors (38) that cause the rollers (32), which feed the wire electrode (12) toward the workpiece (W) from the wire bobbin (30) on which the wire electrode (12) is wound, to rotate, it is estimated whether or not the wire electrode (12) is disconnected.

The rollers (32) may be configured to feed the wire electrode (12) after having passed through the workpiece (W), toward the collection box (24). In accordance with this feature, based on the information obtained from the motors (38) that cause the rollers (32), which feed, toward the collection box (24), the wire electrode (12) after having passed through the workpiece (W), to rotate, it is estimated whether or not the wire electrode (12) is disconnected.

The rollers (32) may include the first roller (32A) that feeds the wire electrode (12) toward the workpiece (W) from the wire bobbin (30) on which the wire electrode (12) is wound, and the second roller (32B) that feeds the wire electrode (12) after having passed through the workpiece (W), toward the collection box (24), the motors (38) may include the first motor (38A) that causes the first roller (32A) to rotate, and the second motor (38B) that causes the second roller (32B) to rotate, and the estimation unit (60) may include the first estimation unit (66) that estimates whether or not the wire electrode (12) is disconnected based on at least one of the disturbance load, the rotational speed, or the torque command of the first motor (38A), the second estimation unit (68) that estimates whether or not the wire electrode (12) is disconnected based on at least one of the disturbance load, the rotational speed, or the torque command of the second motor (38B), and the determination unit (70) that determines as the estimation result that the wire electrode (12) is disconnected, in the case that both the first estimation unit (66) and the second estimation unit (68) have estimated that the wire electrode (12) is disconnected. In accordance with such features, the reliability of the estimation result is improved.

The first estimation unit (66) may estimate whether or not the wire electrode (12) is disconnected, based on whether or not, from among the disturbance load, the rotational speed, and the torque command of the first motor (38A), the value acquired by the acquisition unit (58) has fallen outside of the predetermined range. In accordance with this feature, based on the information obtained from the first motor (38A), it is estimated whether or not the wire electrode (12) is disconnected.

The first estimation unit (66) may estimate whether or not the wire electrode (12) is disconnected, based on whether or not, from among the disturbance load, the rotational speed, and the torque command of the first motor (38A), the value acquired by the acquisition unit (58) has fallen outside of the predetermined range, and may further estimate whether or not the wire electrode (12) is disconnected, based on whether or not, from among the disturbance load, the rotational speed, and the torque command, the amount of change per unit time in the value acquired by the acquisition unit (58) has exceeded the predetermined threshold value, and in the case that the value acquired by the acquisition unit (58) has fallen outside of the range, and the amount of change has exceeded the threshold value, then as the estimation result of the first estimation unit (66), the wire electrode (12) may be determined to be disconnected. In accordance with such features, the reliability of the estimation result of the first estimation unit (66) is improved.

The first estimation unit (66) may estimate whether or not the wire electrode (12) is disconnected, based on whether or not, from among the disturbance load, the rotational speed, and the torque command of the first motor (38A), the amount of change per unit time in the value acquired by the acquisition unit (58) has exceeded the predetermined threshold value. In accordance with this feature, based on the information obtained from the first motor (38A), it is estimated whether or not the wire electrode (12) is disconnected.

The second estimation unit (68) may estimate whether or not the wire electrode (12) is disconnected, based on whether or not, from among the disturbance load, the rotational speed, and the torque command of the second motor (38B), the value acquired by the acquisition unit (58) has fallen outside of the predetermined range. In accordance with this feature, based on the information obtained from the second motor (38B), it is estimated whether or not the wire electrode (12) is disconnected.

The second estimation unit (68) may estimate whether or not the wire electrode (12) is disconnected, based on whether or not, from among the disturbance load, the rotational speed, and the torque command of the second motor (38B), the value acquired by the acquisition unit (58) has fallen outside of the predetermined range, and may further estimate whether or not the wire electrode (12) is disconnected, based on whether or not, from among the disturbance load, the rotational speed, and the torque command, the amount of change per unit time in the value acquired by the acquisition unit (58) has exceeded the predetermined threshold value, and in the case that the value acquired by the acquisition unit (58) has fallen outside of the range, and the amount of change has exceeded the threshold value, then as the estimation result of the second estimation unit (68), the wire electrode (12) may be determined to be disconnected. In accordance with such features, the reliability of the estimation result of the second estimation unit (68) is improved.

The second estimation unit (68) may estimate whether or not the wire electrode (12) is disconnected, based on whether or not, from among the disturbance load, the rotational speed, and the torque command of the second motor (38B), the amount of change per unit time in the value acquired by the acquisition unit (58) has exceeded the predetermined threshold value. In accordance with this feature, based on the information obtained from the second motor (38B), it is estimated whether or not the wire electrode (12) is disconnected.

### <Second Invention>

The estimation method for estimating whether or not the wire electrode (12) is disconnected, in relation to the wire electrical discharge machine (10) equipped with the rollers (32) that feed the wire electrode (12) in the feeding direction by rotation, and the motors (38) that cause the rollers (32) to rotate, the estimation method including the acquisition step (S1) of acquiring at least one from among the disturbance load based on the drive current of the motors (38), the rotational speed of the motors (38), and the torque command in order to cause the motors (38) to rotate at the predetermined command speed, and the estimation step (S2) of estimating whether or not the wire electrode (12) is disconnected, based on at least one from among the disturbance load, the rotational speed, and the torque command acquired in the acquisition step (S1).

In accordance with such features, it is possible to provide the estimation method for estimating whether or not the wire electrode (12) is disconnected, based on the information obtained from the motors (38) included in the feeding mechanism (22) for feeding the wire electrode (12).

In the estimation step (S2), it may be estimated whether or not the wire electrode (12) is disconnected, based on whether or not, from among the disturbance load, the rotational speed, and the torque command, the value acquired in the acquisition step (S1) has fallen outside of the predetermined range. In accordance with this feature, based on the information obtained from the motors (38), it is estimated whether or not the wire electrode (12) is disconnected.

In the estimation step (S2), it may be estimated whether or not the wire electrode (12) is disconnected, based on whether or not, from among the disturbance load, the rotational speed, and the torque command, the value acquired in the acquisition step (S1) has fallen outside of the predetermined range, and it may be further estimated whether or not the wire electrode (12) is disconnected, based on whether or not, from among the disturbance load, the rotational speed, and the torque command, the amount of change per unit time in the value acquired in the acquisition step (S1) has exceeded the predetermined threshold value, and in the case that the value acquired in the acquisition step (S1) has fallen outside of the range, and the amount of change has exceeded the threshold value, then as the estimation result, the wire electrode (12) may be determined to be disconnected. In accordance with such features, the reliability of the estimation result is improved.

In the estimation step (S2), it may be estimated whether or not the wire electrode (12) is disconnected, based on whether or not, from among the disturbance load, the rotational speed, and the torque command, the amount of change per unit time in the value acquired in the acquisition step (S1) has exceeded the predetermined threshold value. In accordance with this feature, based on the information obtained from the motors (38), it is estimated whether or not the wire electrode (12) is disconnected.

The rollers (32) may be configured to feed the wire electrode (12) toward the workpiece (W) from the wire bobbin (30) on which the wire electrode (12) is wound. In accordance with this feature, based on the information obtained from the motors (38) that cause the rollers (32), which feed the wire electrode (12) toward the workpiece (W) from the wire bobbin (30) on which the wire electrode (12) is wound, to rotate, it is estimated whether or not the wire electrode (12) is disconnected.

The rollers (32) may be configured to feed the wire electrode (12) after having passed through the workpiece (W), toward the collection box (24). In accordance with this feature, based on the information obtained from the motors (38) that cause the rollers (32), which feed the wire electrode (12) after having passed through the workpiece (W), toward the collection box (24), to rotate, it is estimated whether or not the wire electrode (12) is disconnected.

The rollers (32) may include the first roller (32A) that feeds the wire electrode (12) toward the workpiece (W) from the wire bobbin (30) on which the wire electrode (12) is wound, and the second roller (32B) that feeds the wire electrode (12) after having passed through the workpiece (W), toward the collection box (24), the motors (38) may include the first motor (38A) that causes the first roller (32A) to rotate, and the second motor (38B) that causes the second roller (32B) to rotate, and the estimation step (S2) may include the first estimation step (S3) of estimating whether or not the wire electrode (12) is disconnected based on at least one of the disturbance load, the rotational speed, or the torque command of the first motor (38A), the second estimation step (S4) of estimating whether or not the wire electrode (12) is disconnected based on at least one of the disturbance load, the rotational speed, or the torque command of the second motor (38B), and the determination step (S5) of determining as the estimation result that the wire electrode (12) is disconnected, in the case that both the first estimation step (S3) and the second estimation step (S4) have estimated that the wire electrode (12) is disconnected. In accordance with such features, the reliability of the estimation result is improved.

In the first estimation step (S3), it may be estimated whether or not the wire electrode (12) is disconnected, based on whether or not, from among the disturbance load, the rotational speed, and the torque command of the first motor (38A), the value acquired in the acquisition step (S1) has fallen outside of the predetermined range. In accordance with this feature, based on the information obtained from the first motor (38A), it is estimated whether or not the wire electrode (12) is disconnected.

In the first estimation step (S3), it may be estimated whether or not the wire electrode (12) is disconnected, based on whether or not, from among the disturbance load, the rotational speed, and the torque command of the first motor (38A), the value acquired in the acquisition step (S1) has fallen outside of the predetermined range, and it may further be estimated whether or not the wire electrode (12) is disconnected, based on whether or not, from among the disturbance load, the rotational speed, and the torque command, the amount of change per unit time of the value acquired in the acquisition step (S1) has exceeded the predetermined threshold value, and in the case that the value acquired in the acquisition step (S1) has fallen outside of the range, and the amount of change has exceeded the threshold value, then as the estimation result of the first estimation step (S3), the wire electrode (12) may be determined to be disconnected. In accordance with such features, the reliability of the estimation result in the first estimation step (S3) is improved.

In the first estimation step (S3), it may be estimated whether or not the wire electrode (12) is disconnected, based on whether or not, from among the disturbance load, the rotational speed, and the torque command of the first motor (38A), the amount of change per unit time in the value acquired in the acquisition step (S1) has exceeded the predetermined threshold value. In accordance with this feature, based on the information obtained from the first motor (38A), it is estimated whether or not the wire electrode (12) is disconnected.

In the second estimation step (S4), it may be estimated whether or not the wire electrode (12) is disconnected, based on whether or not, from among the disturbance load, the rotational speed, and the torque command of the second motor (38B), the value acquired in the acquisition step (S1) has fallen outside of the predetermined range. In accordance with this feature, based on the information obtained from the second motor (38B), it is estimated whether or not the wire electrode (12) is disconnected.

In the second estimation step (S4), it may be estimated whether or not the wire electrode (12) is disconnected, based on whether or not, from among the disturbance load, the rotational speed, and the torque command of the second motor (38B), the value acquired in the acquisition step (S1) has fallen outside of the predetermined range, and it may further be estimated whether or not the wire electrode (12) is disconnected, based on whether or not, from among the disturbance load, the rotational speed, and the torque command, the amount of change per unit time in the value acquired in the acquisition unit (S1) has exceeded the predetermined threshold value, and in the case that the value acquired in the acquisition step (S1) has fallen outside of the range, and the amount of change has exceeded the threshold value, then as the estimation result of the second estimation step (S4), the wire electrode (12) may be determined to be disconnected. In accordance with such features, the reliability of the estimation result in the second estimation step (S4) is improved.

In the second estimation step (S4), it may be estimated whether or not the wire electrode (12) is disconnected, based on whether or not, from among the disturbance load, the rotational speed, and the torque command of the second motor (38B), the amount of change per unit time in the value acquired in the acquisition step (S1) has exceeded the predetermined threshold value. In accordance with this feature, based on the information obtained from the second motor (38B), it is estimated whether or not the wire electrode (12) is disconnected.

1. A control device for a wire electrical discharge machine equipped with a roller configured to feed a wire electrode in a feeding direction by rotation, and a motor configured to cause the roller to rotate, the control device for the wire electrical discharge machine comprising:
an acquisition unit configured to acquire at least one from among a value of a disturbance load based on a drive current of the motor, a value of a rotational speed of the motor, and a value of a torque command in order to cause the motor to rotate at a predetermined command speed; and
an estimation unit configured to estimate whether or not the wire electrode is disconnected, based on at least one from among the disturbance load, the rotational speed, and the torque command acquired by the acquisition unit.

2. The control device for the wire electrical discharge machine according to claim 1, wherein the estimation unit estimates whether or not the wire electrode is disconnected, based on whether or not, from among the disturbance load, the rotational speed, and the torque command, the value acquired by the acquisition unit has fallen outside of a predetermined range.

3. The control device for the wire electrical discharge machine according to claim 2, wherein:
the estimation unit further estimates whether or not the wire electrode is disconnected, based on whether or not, from among the disturbance load, the rotational speed, and the torque command, an amount of change per unit time in the value acquired by the acquisition unit has exceeded a predetermined threshold value; and
in a case that the value acquired by the acquisition unit has fallen outside of the range, and the amount of change has exceeded the threshold value, then as an estimation result, the wire electrode is determined to be disconnected.

4. The control device for the wire electrical discharge machine according to claim 1, wherein the estimation unit estimates whether or not the wire electrode is disconnected, based on whether or not, from among the disturbance load, the rotational speed, and the torque command, an amount of change per unit time in the value acquired by the acquisition unit has exceeded a predetermined threshold value.

5. The control device for the wire electrical discharge machine according to claim 1, wherein the roller is configured to feed the wire electrode toward a workpiece (W) from a wire bobbin on which the wire electrode is wound.

6. The control device for the wire electrical discharge machine according to claim 1, wherein the roller is configured to feed the wire electrode after having passed through a workpiece, toward a collection box.

7. The control device for the wire electrical discharge machine according to claim 1, wherein:
the roller comprises a first roller configured to feed the wire electrode toward a workpiece from a wire bobbin on which the wire electrode is wound, and a second roller configured to feed the wire electrode after having passed through the workpiece, toward a collection box;
the motor comprises a first motor configured to cause the first roller to rotate, and a second motor configured to cause the second roller to rotate; and
the estimation unit comprises a first estimation unit configured to estimate whether or not the wire electrode is disconnected based on at least one of the disturbance load, the rotational speed, or the torque command of the first motor, a second estimation unit configured to estimate whether or not the wire electrode is disconnected based on at least one of the disturbance load, the rotational speed, or the torque command of the second motor, and a determination unit configured to determine as an estimation result that the wire electrode is disconnected, in a case that both the first estimation unit and the second estimation unit have estimated that the wire electrode is disconnected.

8. The control device for the wire electrical discharge machine according to claim 7, wherein the first estimation unit estimates whether or not the wire electrode is disconnected, based on whether or not, from among the disturbance load, the rotational speed, and the torque command of the first motor, the value acquired by the acquisition unit has fallen outside of a predetermined range.

9. The control device for the wire electrical discharge machine according to claim 8, wherein:
the first estimation unit further estimates whether or not the wire electrode is disconnected, based on whether or not, from among the disturbance load, the rotational speed, and the torque command, an amount of change per unit time in the value acquired by the acquisition unit has exceeded a predetermined threshold value; and
in a case that the value acquired by the acquisition unit has fallen outside of the range, and the amount of change has exceeded the threshold value, then as an estimation result of the first estimation unit, the wire electrode is determined to be disconnected.

10. The control device for the wire electrical discharge machine according to claim 7, wherein the first estimation unit estimates whether or not the wire electrode is disconnected, based on whether or not, from among the disturbance load, the rotational speed, and the torque command of the first motor, an amount of change per unit time in the value acquired by the acquisition unit has exceeded a predetermined threshold value.

11. The control device for the wire electrical discharge machine according to claim 7, wherein the second estimation unit estimates whether or not the wire electrode is disconnected, based on whether or not, from among the disturbance load, the rotational speed, and the torque command of the second motor, the value acquired by the acquisition unit has fallen outside of a predetermined range.

12. The control device for the wire electrical discharge machine according to claim 11, wherein:
the second estimation unit further estimates whether or not the wire electrode is disconnected, based on whether or not, from among the disturbance load, the rotational speed, and the torque command, an amount of change per unit time in the value acquired by the acquisition unit has exceeded a predetermined threshold value; and
in a case that the value acquired by the acquisition unit has fallen outside of the range, and the amount of change has exceeded the threshold value, then as an estimation result of the second estimation unit, the wire electrode is determined to be disconnected.

13. The control device for the wire electrical discharge machine according to claim 7, wherein the second estimation unit estimates whether or not the wire electrode is disconnected, based on whether or not, from among the disturbance load, the rotational speed, and the torque command of the second motor, an amount of change per unit time in the value acquired by the acquisition unit has exceeded a predetermined threshold value.

14. An estimation method for estimating whether or not a wire electrode is disconnected, in relation to a wire electrical discharge machine equipped with a roller configured to feed the wire electrode in a feeding direction by rotation, and a motor configured to cause the roller to rotate, the estimation method comprising:
an acquisition step of acquiring at least one from among a disturbance load based on a drive current of the motor, a rotational speed of the motor, and a torque command in order to cause the motor to rotate at a predetermined command speed; and
an estimation step of estimating whether or not the wire electrode is disconnected, based on at least one from among the disturbance load, the rotational speed, and the torque command acquired in the acquisition step.
